(19) United States
(12) Patent Application Publication
(10) Pub. No.: US 2026/0073236 A1
(43) Pub. Date: Mar. 12, 2026

(54) DATA EFFICIENT ALIGNMENT OF LARGE LANGUAGE MODELS

(71) Applicant: NUTANIX, INC., San Jose, CA (US)

(72) Inventors: Rajat GHOSH, San Jose, CA (US); Debojyoti DUTTA, Santa Clara, CA (US); Amrit KHERA, San Francisco, CA (US)

(21) Appl. No.: 19/089,993

(22) Filed: Mar. 25, 2025

Related U.S. Application Data
(60) Provisional application No. 63/693,619, filed on Sep. 11, 2024.

(51) Int. Cl. G06N 3/096

(52) U.S. Cl. CPC G06N 3/096

(57) ABSTRACT

Techniques for data efficient alignment of large language models retrieving a dataset comprising a plurality of alignment data elements; calculating an entropy for the dataset; for each alignment data element, calculate a respective entropy change value based on a difference between the entropy of the dataset and an entropy specific to the alignment data element; and generating an alignment training dataset comprising a subset of the plurality of alignment data elements that are identified based on the respective entropy change values.

### CROSS-REFERENCE TO RELATED APPLICATIONS

This application claims priority benefit of the U.S. Provisional Patent Application titled, “DATA EFFICIENT ALIGNMENT FOR LARGE LANGUAGE MODELS,” filed on Sep. 11, 2024, and having Ser. No. 63/693,619. The subject matter of this related application is hereby incorporated herein by reference.

### BACKGROUND

### Field of the Various Embodiments

Embodiments of the present invention relate generally to generating alignment training datasets for large language models, and more specifically, to techniques for data efficient alignment of large language models.

### DESCRIPTION OF THE RELATED ART

Large Language Models (LLMs) are a type of machine learning model that is designed for processing natural language and/or other types of data. Examples of LLMs include LLMs designed to generate natural language text, answer questions, perform translations, and/or the like. Many LLMs are generative pretrained transformers that are provided one or more prompts and generate natural language that is intended to be responsive to the one or more prompts. When LLMs have been trained on a large corpus of data, the LLMs have demonstrated considerable performance in distilling the knowledge embodied in the data. When appropriately prompted, the LLMs can access the distilled knowledge to provide useful and informed responses.

A pre-trained LLM can be further trained for a specialized purpose using domain adaptive training, fine-tuning or instruction tuning. However, the specialized LLM may produce results which humans may not find desirable, such as a reduced attention to grammatical rules, atypical expression styles, and/or the like. The undesirable characteristics can be mitigated using alignment training, which further trains the specialized LLM based on training data derived from human feedback indicating human preferences. LLMs trained using this human feedback have demonstrated the ability to generate responses with higher ethical, factual, and helpful properties.

One drawback of alignment training is that generating the human feedback in the form of preferences is often tedious and expensive. Techniques, such as Kahneman-Tversky Optimization (KTO), have simplified the human feedback as a binary signal but have not addressed the underlying problem of gathering the human feedback. Moreover, the actual alignment training process can utilize a large amount of resources including time, computing, memory, data storage, network resources, energy, and other resources to present the alignment training data and update the LLM. As a result, the time and resource costs of collating a large alignment training dataset and performing the computational process of aligning an LLM can be prohibitive.

The computational costs of retraining an LLM using alignment training can be reduced by using only a subset of a large alignment training dataset. For example, training LLMs using only a subset of entries selected randomly, a subset of entries based on measures of diversity, or a subset of entries selected by a specially trained LLM (e.g., Ask-LLM) often perform comparably to LLMs trained using the large alignment training dataset. However, the ability of these techniques to select a high-quality subset of entries varies highly for different alignment training datasets.

As a result, there is a need for more effective ways to form alignment training datasets.

### SUMMARY

In various embodiments, one or more non-transitory computer-readable media storing instructions that, when executed by one or more processors, cause the one or more processors to perform steps of retrieving a dataset comprising a plurality of alignment data elements; calculating an entropy for the dataset; for each alignment data element, calculate a respective entropy change value based on a difference between the entropy of the dataset and an entropy specific to the alignment data element; and generating an alignment training dataset comprising a subset of the plurality of alignment data elements that are identified based on the respective entropy change values.

Further embodiments provide, among other things, methods and systems for implementing one or more aspects of the disclosed techniques.

At least one technical advantage of the disclosed techniques relative to prior art is that, with the disclosed techniques, alignment training datasets are generated to be both smaller while be nearly as effective as larger feedback-indicating datasets. Further, the disclosed techniques reduce storage resource usage for the alignment training dataset and also reduce computational or compute resources during alignment training by reducing training time, processing costs, memory usage, and/or energy consumed. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIGS. 1A-1D are block diagrams illustrating virtualization system architectures configured to implement one or more aspects of the present embodiments.

FIG. 2 is a block diagram illustrating a computing environment configured to implement one or more aspects of the present embodiments.

FIG. 3 is an example of win rates for an LLM trained based on a percentage of alignment data elements in a feedback-indicating dataset, according to various embodiments.

FIG. 4 sets forth a flow diagram of method steps for alignment training of an LLM, according to various embodiments.

### DETAILED DESCRIPTION

In the following description, various concepts and examples are disclosed that provide more effective techniques for accessing business data using executable code included in authorization identifiers. The numerous specific details set forth will provide artisans with a more thorough understanding of the various embodiments. However, it will be apparent to one skilled in the art that the inventive concepts can be practiced without one or more of these specific details.

### Exemplary Virtualization System Architectures

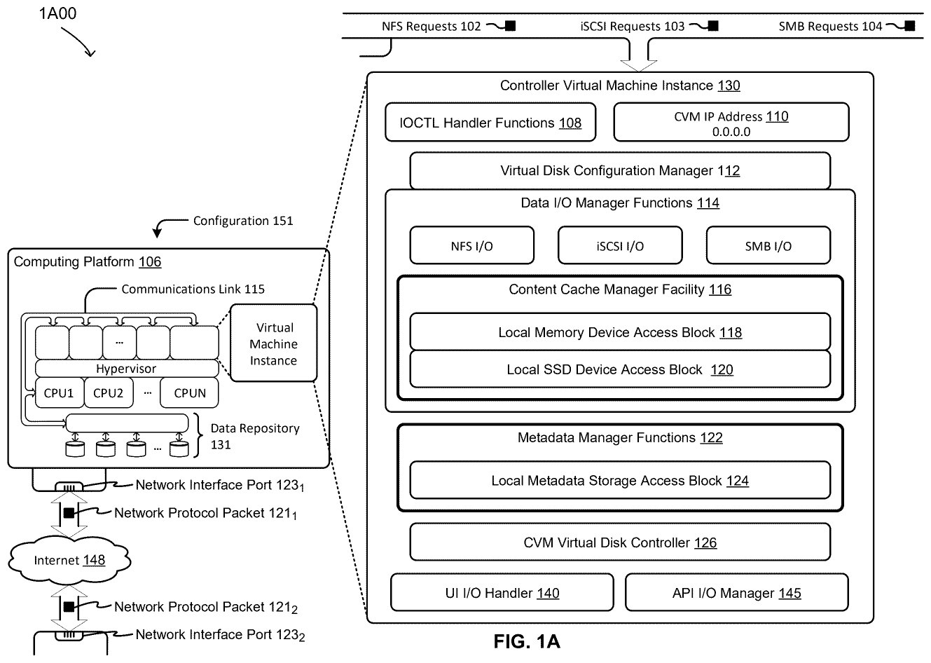

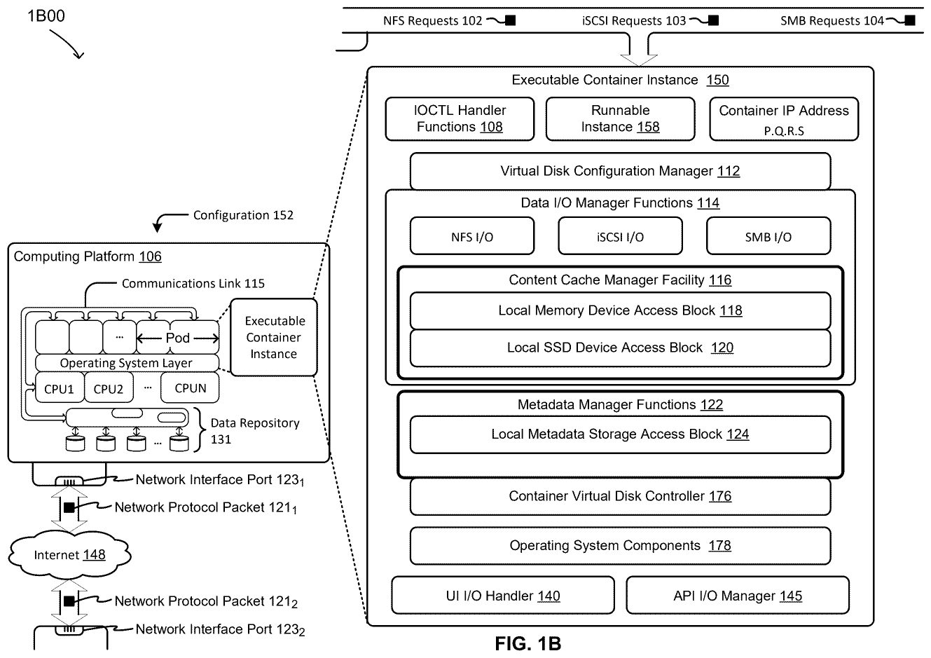

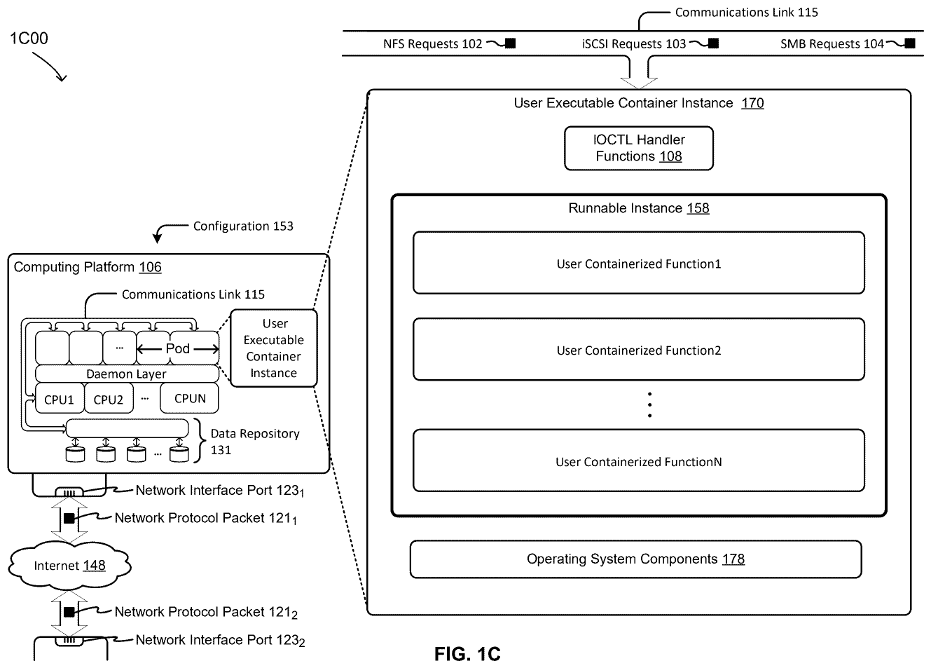

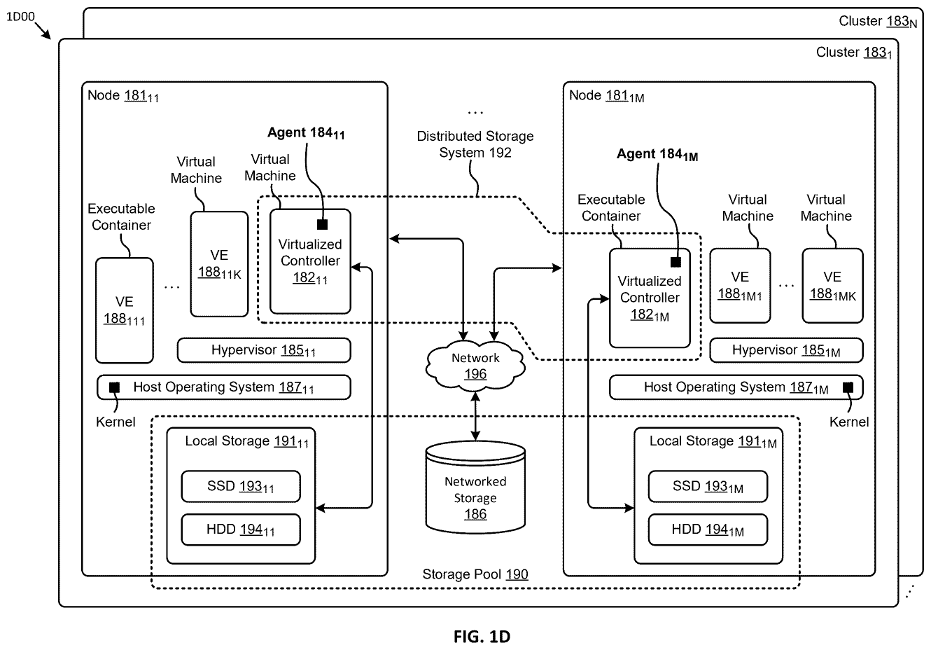

According to some embodiments, all or portions of any of the disclosed techniques can be partitioned into one or more modules and instances within, or as, or in conjunction with a virtualized controller in a virtual computing environment. Some example instances within various virtual computing environments are shown and discussed in further detail in FIGS. 1A-1D. Consistent with these embodiments, a virtualized controller includes a collection of software instructions that serve to abstract details of underlying hardware or software components from one or more higher-level processing entities. In some embodiments, a virtualized controller can be implemented as a virtual machine, as an executable container, or within a layer (e.g., such as a layer in a hypervisor). Consistent with these embodiments, distributed systems include collections of interconnected components that are designed for, or dedicated to, storage operations as well as being designed for, or dedicated to, computing and/or networking operations.

In some embodiments, interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

In some embodiments, a hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

In some embodiments, physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

FIG. 1A is a block diagram illustrating virtualization system architecture 1A00 configured to implement one or more aspects of the present embodiments. As shown in FIG. 1A, virtualization system architecture 1A00 includes a collection of interconnected components, including a controller virtual machine (CVM) instance 130 in a configuration 151. Configuration 151 includes a computing platform 106 that supports virtual machine instances that are deployed as user virtual machines, or controller virtual machines or both. Such virtual machines interface with a hypervisor (as shown). In some examples, virtual machines can include processing of storage I/O (input/output or IO) as received from any or every source within the computing platform. An example implementation of such a virtual machine that processes storage I/O is depicted as CVM instance 130.

In this and other configurations, a CVM instance receives block I/O storage requests as network file system (NFS) requests in the form of NFS requests 102, internet small computer storage interface (ISCSI) block IO requests in the form of iSCSI requests 103, Samba file system (SMB) requests in the form of SMB requests 104, and/or the like. The CVM instance publishes and responds to an internet protocol (IP) address (e.g., CVM IP address 110). Various forms of input and output can be handled by one or more IO control handler functions (e.g., IOCTL handler functions 108) that interface to other functions such as data IO manager functions 114 and/or metadata manager functions 122. As shown, the data IO manager functions can include communication with virtual disk configuration manager 112 and/or can include direct or indirect communication with any of various block IO functions (e.g., NFS IO, ISCSI IO, SMB IO, etc.).

In addition to block IO functions, configuration 151 supports IO of any form (e.g., block IO, streaming IO, packet-based IO, HTTP traffic, etc.) through either or both of a user interface (UI) handler such as UI IO handler 140 and/or through any of a range of application programming interfaces (APIs), possibly through API IO manager 145.

Communications link 115 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), formatting of bit fields into fixed-length blocks or into variable length fields used to populate the payload, and/or the like. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry can be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

Computing platform 106 includes one or more computer readable media that is capable of providing instructions to a data processor for execution. In some examples, each of the computer readable media can take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random-access persistent memories (RAPMs) or optical or magnetic media drives such as paper tape or magnetic tape drives. Volatile media includes dynamic memory such as random-access memory (RAM). As shown, controller virtual machine instance 130 includes content cache manager facility 116 that accesses storage locations, possibly including local dynamic random-access memory (DRAM) (e.g., through local memory device access block 118) and/or possibly including accesses to local solid-state storage (e.g., through local SSD device access block 120).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of data repository 131, which in turn can be formatted into any one or more storage areas, and which can comprise parameterized storage accessible by a key (e.g., a filename, a table name, a block address, an offset address, etc.). Data repository 131 can store any forms of data and can comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 124. The data repository 131 can be configured using CVM virtual disk controller 126, which can in turn manage any number or any configuration of virtual disks.

Execution of a sequence of instructions to practice certain of the disclosed embodiments is performed by one or more instances of a software instruction processor, or a processing element such as a data processor, or such as a central processing unit (e.g., CPU1, CPU2, . . . , CPUN). According to certain embodiments of the disclosure, two or more instances of configuration 151 can be coupled by communications link 115 (e.g., backplane, LAN, PSTN, wired or wireless network, etc.) and each instance can perform respective portions of sequences of instructions as can be required to practice embodiments of the disclosure.

The shown computing platform 106 is interconnected to the Internet 148 through one or more network interface ports (e.g., network interface port 1231 and network interface port 1232). Configuration 151 can be addressed through one or more network interface ports using an IP address. Any operational element within computing platform 106 can perform sending and receiving operations using any of a range of network protocols, possibly including network protocols that send and receive packets (e.g., network protocol packet 1211 and network protocol packet 1212).

Computing platform 106 can transmit and receive messages that can be composed of configuration data and/or any other forms of data and/or instructions organized into a data structure (e.g., communications packets). In some cases, the data structure includes program instructions (e.g., application code) communicated through the Internet 148 and/or through any one or more instances of communications link 115. Received program instructions can be processed and/or executed by a CPU as it is received and/or program instructions can be stored in any volatile or non-volatile storage for later execution. Program instructions can be transmitted via an upload (e.g., an upload from an access device over the Internet 148 to computing platform 106). Further, program instructions and/or the results of executing program instructions can be delivered to a particular user via a download (e.g., a download from computing platform 106 over the Internet 148 to an access device).

Configuration 151 is merely one example configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

In some embodiments, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to management of block stores. Various implementations of the data repository comprise storage media organized to hold a series of records and/or data structures.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT,” issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT,” issued on Oct. 1, 2013, which is hereby incorporated by reference in its entirety.

FIG. 1B depicts a block diagram illustrating another virtualization system architecture 1B00 configured to implement one or more aspects of the present embodiments. As shown in FIG. 1B, virtualization system architecture 1B00 includes a collection of interconnected components, including an executable container instance 150 in a configuration 152. Configuration 152 includes a computing platform 106 that supports an operating system layer (as shown) that performs addressing functions such as providing access to external requestors (e.g., user virtual machines or other processes) via an IP address (e.g., “P.Q.R.S”, as shown). Providing access to external requestors can include implementing all or portions of a protocol specification (e.g., “http:”) and possibly handling port-specific functions. In some embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node can communicate directly with storage devices on the second node.

The operating system layer can perform port forwarding to any executable container (e.g., executable container instance 150). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and can include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “Is” or “Is -a”, etc.). The executable container might optionally include operating system components 178, however such a separate set of operating system components need not be provided. As an alternative, an executable container can include runnable instance 158, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 176. Such a container virtual disk controller can perform any of the functions that the aforementioned CVM virtual disk controller 126 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 1C is a block diagram illustrating virtualization system architecture 1C00 configured to implement one or more aspects of the present embodiments. As shown in FIG. 1C, virtualization system architecture 1C00 includes a collection of interconnected components, including a user executable container instance in configuration 153 that is further described as pertaining to user executable container instance 170. Configuration 153 includes a daemon layer (as shown) that performs certain functions of an operating system.

User executable container instance 170 comprises any number of user containerized functions (e.g., user containerized function1, user containerized function2, . . . , user containerized functionN). Such user containerized functions can execute autonomously or can be interfaced with or wrapped in a runnable object to create a runnable instance (e.g., runnable instance 158). In some cases, the shown operating system components 178 comprise portions of an operating system, which portions are interfaced with or included in the runnable instance and/or any user containerized functions. In some embodiments of a daemon-assisted containerized architecture, computing platform 106 might or might not host operating system components other than operating system components 178. More specifically, the shown daemon might or might not host operating system components other than operating system components 178 of user executable container instance 170.

In some embodiments, the virtualization system architecture 1A00, 1B00, and/or 1C00 can be used in any combination to implement a distributed platform that contains multiple servers and/or nodes that manage multiple tiers of storage where the tiers of storage might be formed using the shown data repository 131 and/or any forms of network accessible storage. As such, the multiple tiers of storage can include storage that is accessible over communications link 115. Such network accessible storage can include cloud storage or networked storage (e.g., a SAN or storage area network).

Unlike prior approaches, the disclosed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In some embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

In some embodiments, any one or more of the aforementioned virtual disks can be structured from any one or more of the storage devices in the storage pool. In some embodiments, a virtual disk is a storage abstraction that is exposed by a controller virtual machine or container to be used by another virtual machine or container. In some embodiments, the virtual disk is exposed by operation of a storage protocol such as iSCSI or NFS or SMB. In some embodiments, a virtual disk is mountable. In some embodiments, a virtual disk is mounted as a virtual storage device.

In some embodiments, some or all of the servers or nodes run virtualization software. Such virtualization software might include a hypervisor (e.g., as shown in configuration 151) to manage the interactions between the underlying hardware and user virtual machines or containers that run client software.

Distinct from user virtual machines or user executable containers, a special controller virtual machine (e.g., as depicted by controller virtual machine instance 130) or as a special controller executable container is used to manage certain storage and I/O activities. Such a special controller virtual machine is sometimes referred to as a controller executable container, a service virtual machine (SVM), a service executable container, or a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 1D is a block diagram illustrating virtualization system architecture 1D00 configured to implement one or more aspects of the present embodiments. As shown in FIG. 1D, virtualization system architecture 1D00 includes a distributed virtualization system that includes multiple clusters (e.g., cluster 183₁, . . . , cluster 183_{N}) comprising multiple nodes that have multiple tiers of storage in a storage pool. Representative nodes (e.g., node 181₁₁, . . . , node 181_{1M}) and storage pool 190 associated with cluster 183₁ are shown. Each node can be associated with one server, multiple servers, or portions of a server. The nodes can be associated (e.g., logically and/or physically) with the clusters. As shown, the multiple tiers of storage include storage that is accessible through a network 196, such as a networked storage 186 (e.g., a storage area network or SAN, network attached storage or NAS, etc.). The multiple tiers of storage further include instances of local storage (e.g., local storage 191₁₁, . . . , local storage 191_{1M}). For example, the local storage can be within or directly attached to a server and/or appliance associated with the nodes. Such local storage can include solid state drives (SSD 193₁₁, . . . , SSD 193_{1M}), hard disk drives (HDD 194₁₁, . . . , HDD 194_{1M}), and/or other storage devices.

As shown, any of the nodes of the distributed virtualization system can implement one or more user virtualized entities (e.g., VE 188¹¹¹, . . . , VE 188^{11K}, . . . , VE 188^{1M1}, . . . , VE 188^{1MK}), such as virtual machines (VMs) and/or executable containers. The VMs can be characterized as software-based computing “machines” implemented in a container-based or hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 187¹¹, . . . , host operating system 187^{1M}), while the VMs run multiple applications on various respective guest operating systems. Such flexibility can be facilitated at least in part by a hypervisor (e.g., hypervisor 185¹¹, . . . , hypervisor 185^{1M}), which hypervisor is logically located between the various guest operating systems of the VMs and the host operating system of the physical infrastructure (e.g., node).

As an alternative, executable containers can be implemented at the nodes in an operating system-based virtualization environment or in a containerized virtualization environment. The executable containers are implemented at the nodes in an operating system virtualization environment or container virtualization environment. The executable containers can include groups of processes and/or resources (e.g., memory, CPU, disk, etc.) that are isolated from the node host computer and other containers. Such executable containers directly interface with the kernel of the host operating system (e.g., host operating system 187¹¹, . . . , host operating system 187_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 190 by the VMs and/or the executable containers.

Multiple instances of such virtualized controllers can coordinate within a cluster to form the distributed storage system 192 which can, among other operations, manage the storage pool 190. This architecture further facilitates efficient scaling in multiple dimensions (e.g., in a dimension of computing power, in a dimension of storage space, in a dimension of network bandwidth, etc.).

In some embodiments, a particularly configured instance of a virtual machine at a given node can be used as a virtualized controller in a hypervisor-assisted virtualization environment to manage storage and I/O (input/output or IO) activities of any number or form of virtualized entities. For example, the virtualized entities at node 181₁₁ can interface with a controller virtual machine (e.g., virtualized controller 18211) through hypervisor 185₁₁ to access data of storage pool 190. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 192. For example, a hypervisor at one node in the distributed storage system 192 might correspond to software from a first vendor, and a hypervisor at another node in the distributed storage system 192 might correspond to a second software vendor. As another virtualized controller implementation example, executable containers can be used to implement a virtualized controller (e.g., virtualized controller 182_{1M}) in an operating system virtualization environment at a given node. In this case, for example, the virtualized entities at node 181_{1M} can access the storage pool 190 by interfacing with a controller container (e.g., virtualized controller 182_{1M}) through hypervisor 185_{1M} and/or the kernel of host operating system 187_{1M}.

In some embodiments, one or more instances of an agent can be implemented in the distributed storage system 192 to facilitate the herein disclosed techniques. Specifically, agent 184₁₁ can be implemented in the virtualized controller 182₁₁, and agent 184_{1M} can be implemented in the virtualized controller 182_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or the agents.

### Alignment Training of LLMs

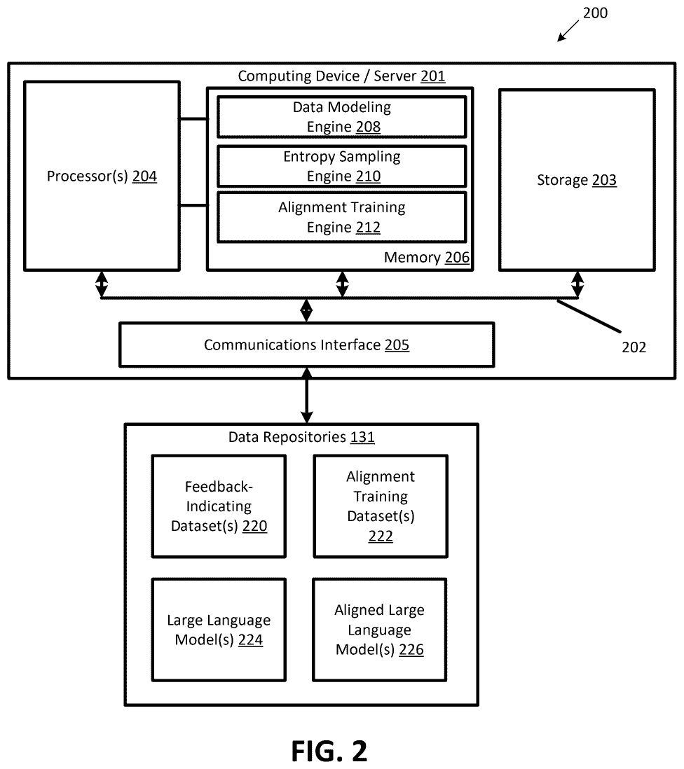

FIG. 2 is a block diagram illustrating a computing environment 200 configured to implement one or more aspects of the present embodiments. As shown, the computing environment 200 includes, without limitation, a computing device or server 201 and one or more data repositories 131. The server 201 includes, without limitation, interconnect 202, storage 203, one or more processors 204, a communications interface 205, and a memory 206. Memory 206 includes, without limitation, a data modeling engine 208, an entropy sampling engine 210, and an alignment training engine 212. The data repositories 131 include, without limitation, one or more feedback-indicating datasets 220, one or more alignment training datasets 222, one or more LLMs 224, and one or more aligned LLMs 226. While data modeling engine 208, entropy sampling engine 210, and alignment training engine 212 are shown in the memory 206, they can also be stored in the storage 203 and/or data repositories 131.

The computing environment 200 described herein is illustrative and any other technically feasible configurations fall within the scope of the present disclosure. In some embodiments, data modeling engine 208, entropy sampling engine 210, and/or alignment training engine 212 can be located in two or more different computing devices. In some embodiments, each of feedback indicating dataset(s) 220, alignment training datasets 222, LLM 224, and/or aligned LLMs 226 can be located in any combination of data repositories 131. Further, in the context of this disclosure, the computing elements shown in the computing environment 200 can correspond to a physical computing system (e.g., a system in a data center) or can include a virtual computing instance. The components of the computing environment 200 of FIG. 2 can be included in any of the virtualization system architectures shown in FIGS. 1A-1D.

Interconnect 202 can be any technically feasible set of components that interconnect subsystems and devices within server 201, such as storage 203, the one or more processors 204, communications interface 205 and memory 206. Interconnect 202 can include one more parallel or serial buses

Storage 203 includes, without limitation, non-volatile storage for applications and data, and may include one or more fixed or removable disk drives, hard disk dirves (HDDs), solid state drives (SSDs), non-volatile memories (NVMes), virtual disks (vDisks), flash memory devices, and/or other magnetic, optical, and/or solid-state storage devices. In some examples, storage 203 can be separate from the data repositories 131. However, storage 203 can include one or more of the data repositories 131. Storage 203 can include physical storage devices of a storage cluster. The storage 203 include, without limitation, non-volatile storage for applications and data, and may include one or more fixed or removable disk drives, HDDs, SSD, NVMes, vDisks, flash memory devices, and/or other magnetic, optical, and/or solid-state storage devices.

The one or more processors 204 include any suitable processors implemented as a central processing unit (CPU), a graphics processing unit (GPU), an application-specific integrated circuit (ASIC), a field programmable gate array (FPGA), an artificial intelligence (AI) accelerator, any other type of processor, or a combination of different processors, such as a CPU configured to operate in conjunction with a GPU. In general, the one or more processors 204 can be any technically feasible hardware unit capable of processing data and/or executing software applications.

Memory 206 includes a random-access memory (RAM) module, a flash memory unit, and/or any other type of memory unit or combination thereof. The one or more processors 204 and/or communications interface 205 are configured to read data from and write data to memory 206. Memory 206 includes various software programs that include one or more instructions that can be executed by the one or more processors 204 and application data associated with the software programs.

Communications interface 205 is configured to transmit and/or receive information between server 201 and one or more other devices, such as data repositories 131, other computing devices, and/or the like using a network (not shown). Communications interface can include any technically feasible combination of hardware and/or software providing interfaces, buffers, and/or the like for communicating with any type of local-area network (e.g., a wired or wireless Ethernet), wide-area network (e.g., the Internet), and/or the like.

Each of feedback-indicating dataset(s) 220 includes a plurality of alignment data elements. In some embodiments, an alignment data element includes an input x, corresponding to a sample of input provided to one of the LLMs 224, and preference information for the output of the LLM 224 in the form of y_{w}, corresponding to a preferred output, and yₗ, corresponding to a dispreferred output. In such cases, a complete feedback-indicating dataset 220 corresponds to (D: (x, y_{w}, yₗ)|y_{w} [symbol] yₗ∀x). Because each of the alignment data elements can include desirable and/or undesirable examples of outputs y for each input x, a feedback-indicating dataset 220 can include two “conversations.” A first conversation with desired outputs y_{w} and a second conversation with undesired outputs yₗ. In some embodiments, an alignment data element includes an input x, corresponding to a sample of input provided to one of the LLMs 224, an output y of the LLM, and an indication of whether output y of the LLM 224 is desirable/aligned/appropriate/accepted/approved or undesirable/unaligned/inappropriate/rejected. Although inputs x and outputs y are generally natural language text, inputs x and outputs y can include one or more of natural language text, images, audio, video, and/or the like. Similarly, the response data from humans can include one or more of natural language text, images, audio, video, and/or the like. In some embodiments, feedback-indicating data 220 is determined from input-response pairs and user feedback during a session using one or more of LLMs 224. Feedback-indicating datasets 220 can include one or more of the OpenAssistant1 (OAsst) dataset, the Ultrafeedback dataset, the Ultrafeedback-binarized dataset, the Anthropic Golden HH-RLHF (Golden_Anthropic) dataset, and/or the like.

An LLM 224 can be any technically suitable LLM, such as any of the LLaMa, Mistral, GPT, Phi, and/or similar families of LLMs. For example, the LLM could be Alpaca-7B, LLaMa-2-7B-Chat, Dolly-6B, Vicuna-6B, LLaMa-3-8B-instruct, LLaMa 30B, Mistral-7B-v0.1, GPT-40, Pythia 6.9B, and/or the like.

Data modeling engine 208 generates embedded data from the alignment data elements in feedback-indicating dataset(s) 220. In some embodiments, data encoding engine includes an encoder from an LLM (e.g., one of LLM(s) 224). The encoding operation can convert the alignment data elements into respective embedded data. The encoded data includes an n-dimensional distribution of encoded datapoints, where each encoded datapoint corresponds to one of the alignment data elements. The encoded datapoints can also be referred to as encoded alignment data elements, because the encoded datapoints are encoded representations of the alignment data elements. In some embodiments, data modeling engine 208 is part of entropy sampling engine 210.

Entropy sampling engine 210 processes the encoded data to identify a subset of a feedback-indicating dataset 220 and generates an alignment training dataset 222 using the subset of feedback-indicating dataset 220. Entropy sampling engine 210 models the n-dimensional distribution of the encoded data as a Gaussian Mixture Model (GMM) distribution of encoded datapoints corresponding to the encoded alignment data elements. The GMM distribution effectively creates a soft-clustering of the encoded data within the n-dimensional distribution of encoded datapoints. Because feedback-indicating dataset 220 has the two “conversations”, the GMM distribution is modeled as a two-component GMM. The log-likelihood of a particular datapoint in the two-component GMM is given by Equation 1, where π is a mixing coefficient between the two components/conversations, μ₁ and μ₂ are the means of the two components, Σ₁ and Σ₂ are the standard deviations of the two components, and N is the normal distribution.

$$l ( x ) = log [ π N ( x \vert {μ}_{1} , {\sum }_{1} ) + ( 1 - π ) 𝒩 ( x \vert {μ}_{2} , {\sum }_{2} ) ] \qquad Equation 1$$

For each of the encoded datapoints, entropy sampling engine 210 generates the probability of sampling a datapoint x by computing the log-likelihood I(x) and then normalizing I(x) using mix-max scaling to obtain I′(x). The mix-max scaling improves the numerical stability of the log-likelihoods. The probability of selecting datapoint x is then determined using Equation 2.

$$p ( x ) = {e}^{{l}^{′} ( x )} \qquad Equation 2$$

Entropy sampling engine 210 then computes the entropy H(X) of the entire feedback-indicating dataset 220 using Equation 3, where x∈X indicates that the entropy H(X) is computed across all the encoded datapoints corresponding to the alignment data elements of feedback-indicating dataset 220.

$$H ( X ) = - {\sum }_{x ∈ X} p ( x ) log p ( x ) \qquad Equation 3$$

For each encoded datapoint x′ of the encoded datapoints in feedback indicating dataset 220, entropy sampling engine 210 determines an element-specific entropy H(X−x′) using Equation 4 and an entropy change value Δ(x′) using Equation 5, where x∈{X−x′} indicates that entropy H(X−x′) is computed across all the elements of a dataset that has all the entries of feedback-indicating dataset 220 except for the alignment data element corresponding to encoded datapoint x′.

$$H ( X − {x}^{′} ) = − {\sum }_{x ∈ \{ X − {x}^{′} \}} p ( x ) log p ( x ) \qquad Equation 4$$

$$Δ ( {x}^{′} ) = H ( x ) − H ( X − {x}^{′} ) \qquad Equation 5$$

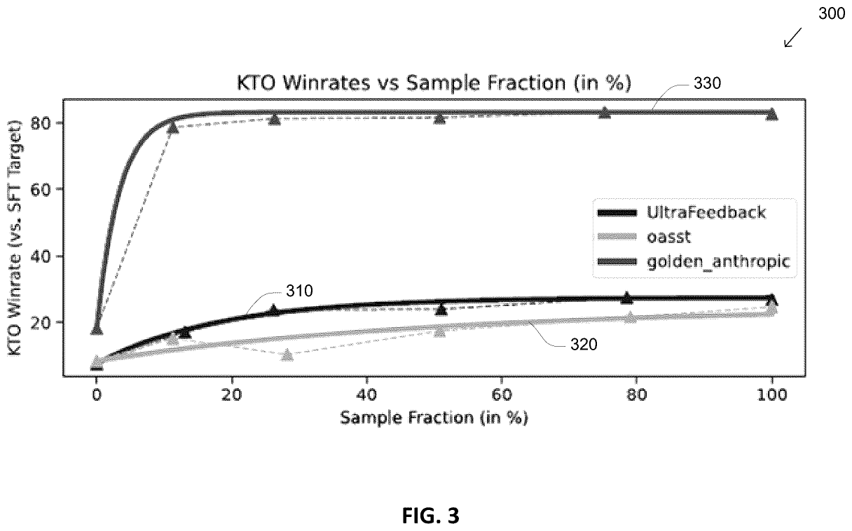

Entropy sampling engine 210 then selects the k alignment data elements that correspond to the encoded datapoints x′ having the highest or largest entropy change values Δ(x′) as the alignment data elements to include in a corresponding alignment training dataset 222. In some embodiments, entropy sampling engine 210 sorts entropy change values Δ(x′) in descending order into a sorted list and then selects the alignment data elements corresponding to the first k entropy change values Δ(x′) in the sorted list. Selecting the encoded datapoints x′ having the highest entropy change values Δ(x′) helps ensure that entropy sampling engine 210 is selecting the alignment data elements that are most likely to help train one of the LLMs 224. The number k of alignment data elements to select can be determined based how well LLM 224 can be alignment trained using alignment training dataset 222 relative to using the entire feedback-indicating dataset 220. Empirical evidence suggests that selecting k to be around ten percent of the alignment data elements in feedback-indicating dataset 220 that have the highest entropy change values Δ(x′) as indicated in FIG. 3 results in an aligned LLM 226 that is almost as effective as an aligned LLM 226 trained on the entire feedback-indicating dataset 220.

FIG. 3 is an example 300 of win rates for an LLM 224 trained based on a percentage of alignment data elements in a feedback-indicating dataset 220, according to various embodiments. The x-axis indicates the percentage (e.g., sample fraction) of the alignment data elements selected from feedback-indicating dataset 220 by entropy sampling engine 210, and the y-axis indicates the win rate when LLM 224 is alignment trained using KTO relative to the win rate when LLM 224 is trained using Lo-rank Adaptation (LoRA) using the entire feedback-indicating dataset 220. FIG. 3 shows the comparative win rates for three feedback-indicating datasets 220. Curve 310 shows the comparative win rates for LLM 224 alignment trained on different percentages of alignment data elements from the Ultrafeedback dataset where the raw comparative win rates (the triangles) are fit using Equation 6. Curve 320 shows the comparative win rates for the same LLM 224 alignment trained on different percentages of alignment data elements from the OAsst dataset. Curve 330 shows the comparative win rates for the same LLM 224 alignment trained on different percentages of alignment data elements from the Golden_Anthropic dataset. As can be seen from each of curves 310, 320, and 330, there are significantly reduced improvements in win rates when more than approximately ten percent of the alignment data elements are selected.

$$R ( x ) = r - ( r - a ) {e}^{- b x} \qquad Equation 6$$

Referring back to FIG. 2, based on the empirical evidence of FIG. 3, entropy sampling engine 210 can select k to be a predetermined number corresponding to ten percent of all the alignment data elements in feedback-indicating dataset 220. This allows alignment training of LLM 224 to generate a corresponding aligned LLM 226 to use approximately ten percent of the computational or compute resources (e.g., training time, processing costs, memory usage, and/or energy consumed) as alignment training LLM 224 using the entire feedback-indicating dataset 220. Entropy sampling engine 210 can further adjust k upward or downward to further control the amount of computational or compute resources used to alignment train LLM 224 to generate corresponding aligned LLM 226.

Alignment training engine 212 trains one or more of LLMs 224 using an alignment training dataset 222 to generate corresponding aligned LLMs 226. Alignment training engine 212 can use any technically suitable training technique to alignment train any of LLM(s) 224 using alignment training dataset 222. For example, alignment training engine 212 can use supervised fine tuning, however, supervised fine tuning is very computationally expensive. More efficient training techniques include parameter-efficient approaches (e.g., LoRA), direct alignment algorithms (e.g., KTO), reinforcement learning algorithms (e.g., proximal policy optimization (PPO), and direct policy optimization (DPO), and/or the like.

Equations 7-9 represent the canonical representation of alignment training on a feedback-indicating dataset 220 corresponding to (D: (x, y_{w}, yₗ)|y_{w} [symbol] yₗ∀x), where r* indicates the true reward underlying the preferences in feedback-indicating dataset 220 p* is a preference function indicating that y_{w} is preferred over yₗ, and σ is the logistic function.

$${max}_{{Φ}_{0}} {\sum }_{t = 1}^{T} log P ( {x}_{t} \vert {x}_{1 : t - 1} ; {Φ}_{0} ) \qquad Equation 7$$

$${max}_{Θ} {\sum }_{( x , y ) ∈ Z} {\sum }_{t = 1}^{T} log {p}_{{Φ}_{0} + Δ Θ ( Θ )} ( {y}_{t} \vert x , {y}_{< t} ) \qquad Equation 8$$

$${p}^{*} ( {y}_{w} ≻ {y}_{l} \vert x ) = σ ( {r}^{*} ( x , {y}_{w} ) - {r}^{*} ( x , {y}_{l} ) ) \qquad Equation 9$$

In practice, the true reward function r* is intractable. Instead a reward model r_{φ} is trained as a proxy for r′ according to Equation 10, which minimizes the negative log-likelihood of the preferences in feedback-indicating dataset 220.

$${𝔼}_{x , yw , yl ∼ D} [ - log σ ( {r}_{ϕ} ( x , {y}_{w} ) - {r}_{ϕ} ( x , {y}_{l} ) ) ] \qquad Equation 10$$

However, the indiscriminate maximization of the reward in Equation 10 occurs at the expense of other desired characteristics, such as the generation of grammatically correct text outputs by the trained LLM. To reduce or minimize the undesirable side effects of training based on Equation 10, an improved reward can be used that includes a consideration of both reward maximization and drift minimization from a reference-aligned LLM, such as an aligned LLM trained using LoRa. The drift minimization can be modeled as Kullback-Leibler (KL) divergence as shown in Equation 11, where β is a hyperparameter, π_{θ} is the LLM being trained, and π_{ref} is the reference-aligned LLM.

$$arg {max}_{{π}_{θ}} {𝔼}_{x ∈ Dy ∼ {π}_{θ}} [ {r}_{ϕ} ( x , y ) ] - β {D}_{K L} ( {π}_{θ} ( y \vert x ) \vert \vert {π}_{ref} ( y \vert x ) ) \qquad Equation 11$$

Unfortunately, Equation 11 is non-differentiable. Instead a human-aware loss function, such as the loss function from DPO as shown in Equation 12, provides a closed-form alternative. Alternatively, the loss function from KTO as shown in Equation 13 can be used when feedback-indicating dataset 220 includes alignment data entries that indicate the desirability of an output (e.g., desirable or undesirable) instead of preference data y_{w} and yₗ. β and λ are corresponding hyperparameters, π_{θ} is the LLM being trained, and π_{ref} is the reference-aligned LLM.

$${L}_{D P O} ( {π}_{θ} , {π}_{ref} ) = {𝔼}_{x , {y}_{w} , {y}_{1} ∼ D} [ - log σ ( β log \frac{{π}_{θ} ( {y}_{w} \vert x )}{{π}_{m e f} ( {y}_{w} \vert x )} - β log \frac{{π}_{θ} ( {y}_{t} \vert x )}{{π}_{ref} ( {y}_{t} \vert x )} ) ] \qquad Equation 12$$

$${L}_{K T O} ( {π}_{θ} , {π}_{x e} ) = {𝔼}_{x , y ∼ D} [ {λ}_{y} - v ( x , y ) ]$$

$$where$$

$${r}_{θ} ( x , y ) = log \frac{{π}_{θ} ( y \vert x )}{{π}_{x f} ( y \vert x )}$$

$${z}_{0} = {𝔼}_{{x}^{′} ∼ D} [ KL ( {π}_{θ} ( {y}^{′} \vert {x}^{′} ) \vert \vert {π}_{rf} ( {y}^{′} \vert {x}^{′} ) ) ] \qquad Equation 13$$

$$v ( x , y ) = \{ \begin{matrix}{λ}_{D} σ ( β ( {r}_{θ} ( x , y ) − {z}_{0} ) ) & if y ∼ {y}_{desinabe} \vert x \\ {λ}_{V} σ ( β ( {z}_{0} − {r}_{θ} ( x , y ) ) ) & if y ∼ {y}_{undesinhic} \vert x\end{matrix}$$

In practice, alignment training engine 212 uses either the loss function of Equation 12 or the loss function of Equation 13 depending on the type of alignment data entries in feedback-indicating dataset 220 and alignment training dataset 222. Using the appropriate loss function, alignment training engine 212 trains LLM 224 to generate corresponding aligned LLM 226.

Each of alignment training dataset(s) 222 includes a subset of alignment data entries from a corresponding feedback-indicating dataset 220 as selected by entropy sampling engine 210. Additionally, alignment training dataset(s) can include different numbers of alignment data entries (e.g., based on different values of k) usable to alignment train an LLM 224 to generate an aligned LLM 226 using different amounts of computing resources.

Each of aligned LLM(s) 226 results from alignment training engine 212 training one of the LLMs 224 using one or the alignment training dataset(s) 222. Each of the aligned LLM(s) 226 can then be used to provide aligned responses to various input data, such as one or more prompts and/or the like.

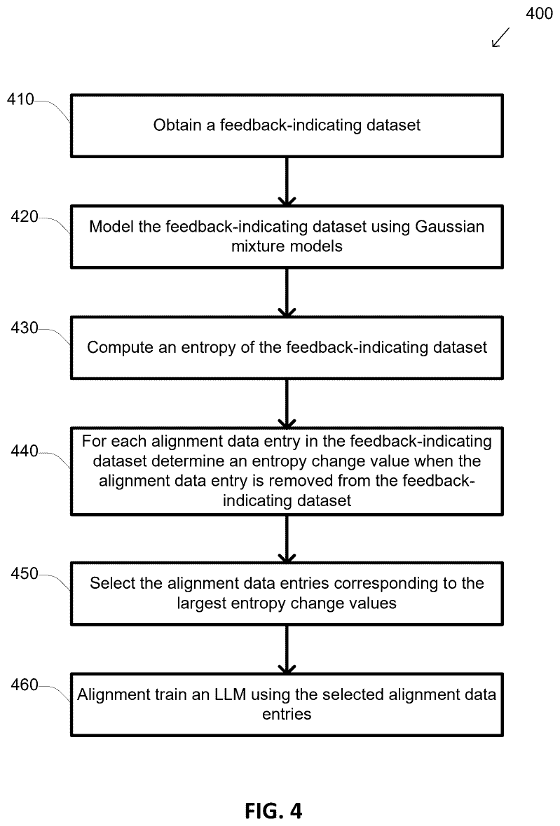

FIG. 4 sets forth a flow diagram of method steps for alignment training of an LLM, according to various embodiments. Although the method steps are described in conjunction with the systems of FIGS. 1A-3, persons of ordinary skill in the art will understand that any system configured to perform the method steps, in any order, is within the scope of the invention.

As shown, a method 400 begins at a step 410, where data modeling engine 208 retrieves a feedback-indicating dataset 220. Data modeling engine 208 can load feedback-indicating dataset 220 from data repositories 131. Feedback-indicating dataset 220 includes a plurality of alignment data elements. In some embodiments, each alignment data element includes an input x, corresponding to a sample of input provided to one of the LLMs 224, and preference information for the output of the LLM 224 in the form of y_{w}, corresponding to a preferred output, and yₗ, corresponding to a dispreferred output. In such cases, a complete feedback-indicating dataset 220 corresponds to (D: (x, y_{w}, yₗ)|y_{w} [symbol] yₗ∀x). In some embodiments, each alignment data element includes an input x, corresponding to a sample of input provided to one of the LLMs 224, an output y of the LLM, and an indication of whether output y of the LLM 224 is desirable or undesirable.

At a step 420, data modeling engine 208 models the feedback-indicating dataset 220 using Gaussian mixture models. Data modeling engine 208 first encodes each of the alignment data elements into encoded data. The encoded data includes an n-dimensional distribution of encoded datapoints, where each encoded datapoint corresponds to one of the alignment data elements. Data modeling engine 208 then soft clusters the encoded datapoints using Gaussian mixture models using Equation 1 to generate a log-likelihood of a particular datapoint. Data modeling engine 208 then normalizes the log-likelihoods using min-max scaling and determines the probability of selecting each of the datapoints using Equation 2.

At a step 430, entropy sampling engine 210 computes an entropy of the feedback-indicating dataset 220. Entropy sampling engine 210 computes the entropy from the probabilities determined during step 420 according to Equation 3.

At a step 440, entropy sampling engine 210 determines an entropy change value when the alignment data entry is removed from feedback-indicating dataset 220 for each alignment data entry in the feedback-indicating dataset 220. For each alignment data entry, entropy sampling engine 210 first removes the alignment data entry from feedback-indicating dataset 220 and then computes the entropy of the resulting dataset according to Equation 4. Entropy sampling engine 210 then determines an entropy change value for the alignment data entry using Equation 5.

At a step 450, entropy sampling engine 210 selects the alignment data entries corresponding to the largest entropy change values. For example, entropy sampling engine 210 can sort the entropy change values in descending order to create a sorted list and then selects the alignment data entries corresponding to the entropy change values at the beginning of the sorted list. In some embodiments, entropy sampling engine 210 selects approximately ten percent of the alignment data entries from feedback-indicating dataset 220. In some embodiments, entropy sampling engine 210 select more than ten percent or less than ten percent of the alignment data entries to increase or decrease the amount of computing resources that will be used when alignment training an LLM 224 using the selected alignment data entries. The selected alignment data entries can then be stored as an alignment training dataset 222.

At a step 460, alignment training engine 212 alignment trains an LLM 224 using the selected alignment data entries. Alignment training engine 212 can use any technically feasible alignment training technique. For example, alignment training engine 212 can use any of supervised fine tuning, parameter-efficient approaches (e.g., LORA), direct alignment (e.g., KTO), reinforcement learning algorithms (e.g., proximal policy optimization (PPO), and direct policy optimization (DPO), and/or the like. After alignment training LLM 224, alignment training engine 212 stores the resulting LLM as aligned LLM 226.

As discussed above and further emphasized here, FIG. 4 is merely an example which should not unduly limit the scope of the claims. One of ordinary skill in the art would recognize many variations, alternatives, and modifications. In some embodiments, step 460 can be repeated multiple times to train different LLMs 224 using the alignment data entries selected during step 450. In some embodiments, steps 450 and 460 be repeated multiple times to select different numbers of alignment data entries for different alignment training datasets 222. In some embodiments, method 400 can be repeated for different feedback-indicating datasets 220.

In sum, the disclosed embodiments describe techniques for generating an effective and reduced size training dataset for faster and more resource-efficient alignment training. The techniques include identifying high-quality datapoints in a feedback-indicating dataset to produce an alignment training dataset with fewer alignment data entries. The techniques include determining differences between the entropy of an entire feedback-indicating dataset and the entropy of the entire feedback-indicating dataset with individual alignment data entries removed. The individual alignment data entries that cause the largest changes in entropy when removed are selected for the alignment training dataset.

At least one technical advantage of the disclosed techniques relative to prior art is that, with the disclosed techniques, alignment training datasets are generated to be both smaller and/or at least equally effective as larger feedback-indicating datasets. Further, the disclosed techniques reduce storage resource usage for the alignment training dataset and also reduce computational or compute resources during alignment training by reducing training time, processing costs, memory usage, and/or energy consumed. These technical advantages provide one or more technological improvements over prior art approaches.
1. In some embodiments, one or more non-transitory computer-readable media store instructions that, when executed by one or more processors, cause the one or more processors to perform steps of retrieving a dataset comprising a plurality of alignment data elements, calculating an entropy for the dataset, for each alignment data element, calculate a respective entropy change value based on a difference between the entropy of the dataset and an entropy specific to the alignment data element, and generating an alignment training dataset comprising a subset of the plurality of alignment data elements that are identified based on the respective entropy change values.
2. The one or more non-transitory computer-readable media of clause 1, wherein the steps further comprise determining the entropy specific to a first alignment data element based on an entropy of the dataset with the first alignment data element removed.
3. The one or more non-transitory computer-readable media of clauses 1 or 2, wherein the steps further comprise training one or more large language models using the alignment training dataset.
4. The one or more non-transitory computer-readable media of any of clauses 1-3, wherein the steps further comprise encoding the plurality of alignment data elements using an encoder from a large language model to generating a plurality of encoded datapoints, and calculating the entropy of the dataset using probabilities of selecting each of the plurality of encoded datapoints.
5. The one or more non-transitory computer-readable media of any of clauses 1-4, wherein the steps further comprise modeling the plurality of encoded datapoints using a Gaussian mixture model.
6. The one or more non-transitory computer-readable media of any of clauses 1-5, wherein the subset of the plurality of alignment data elements includes alignment data elements having respective entropy change values that are larger than respective entropy change values of unselected ones of the plurality of alignment data elements.
7. The one or more non-transitory computer-readable media of any of clauses 1-6, wherein generating the alignment training dataset comprises selecting a predetermined number of alignment data elements corresponding to the plurality of alignment data elements having largest respective entropy change values.
8. The one or more non-transitory computer-readable media of any of clauses 1-7, wherein the predetermined number is ten percent of the alignment data elements in the dataset.
9. The one or more non-transitory computer-readable media of any of clauses 1-8, wherein the predetermined number is selected to control an amount of computing resources used when alignment training a large language model using the alignment training dataset.
10. The one or more non-transitory computer-readable media of any of clauses 1-9, wherein a respective alignment data element of the alignment data elements comprises at least one of input for a large language model, a response from the large language model, an input-response pair associated with the large language model, or a session comprising a plurality of input-response pairs associated with the large language model.
11. In some embodiments, one or more non-transitory computer-readable media store instructions that, when executed by one or more processors, cause the one or more processors to perform steps of retrieving a dataset comprising a plurality of alignment data elements, calculating an entropy for the dataset, for each alignment data element, calculate a respective entropy change value based on a difference between the entropy of the dataset and an entropy specific to the alignment data element, and generating an alignment training dataset comprising a subset of the plurality of alignment data elements that are identified based on the respective entropy change values.
12. The one or more non-transitory computer-readable media of clause 11, wherein the steps further comprise determining the entropy specific to a first alignment data element based on an entropy of the dataset with the first alignment data element removed.
13. The one or more non-transitory computer-readable media of clauses 11 or 12, wherein the steps further comprise training one or more large language models using the alignment training dataset.
14. The one or more non-transitory computer-readable media of any of clauses 11-13, wherein the steps further comprise encoding the plurality of alignment data elements using an encoder from a large language model to generating a plurality of encoded datapoints, and calculating the entropy of the dataset using probabilities of selecting each of the plurality of encoded datapoints.
15. The one or more non-transitory computer-readable media of any of clauses 11-14, wherein the steps further comprise modeling the plurality of encoded datapoints using a Gaussian mixture model.
16. The one or more non-transitory computer-readable media of any of clauses 11-15, wherein the subset of the plurality of alignment data elements includes alignment data elements having respective entropy change values that are larger than respective entropy change values of unselected ones of the plurality of alignment data elements.
17. The one or more non-transitory computer-readable media of any of clauses 11-16, wherein generating the alignment training dataset comprises selecting a predetermined number of alignment data elements corresponding to the plurality of alignment data elements having largest respective entropy change values.
18. The one or more non-transitory computer-readable media of any of clauses 11-17, wherein the predetermined number is ten percent of the alignment data elements in the dataset.
19. The one or more non-transitory computer-readable media of any of clauses 11-18, wherein the predetermined number is selected to control an amount of computing resources used when alignment training a large language model using the alignment training dataset.
20. The one or more non-transitory computer-readable media of any of clauses 11-19, wherein a respective alignment data element of the alignment data elements comprises at least one of input for a large language model, a response from the large language model, an input-response pair associated with the large language model, or a session comprising a plurality of input-response pairs associated with the large language model.
21. In some embodiments, one or more non-transitory computer-readable media store instructions that, when executed by one or more processors, cause the one or more processors to perform steps of retrieving a dataset comprising a plurality of alignment data elements, calculating an entropy for the dataset, for each alignment data element, calculate a respective entropy change value based on a difference between the entropy of the dataset and an entropy specific to the alignment data element, and generating an alignment training dataset comprising a subset of the plurality of alignment data elements that are identified based on the respective entropy change values.
22. The one or more non-transitory computer-readable media of clause 21, wherein the steps further comprise determining the entropy specific to a first alignment data element based on an entropy of the dataset with the first alignment data element removed.
23. The one or more non-transitory computer-readable media of clauses 21 or 22, wherein the steps further comprise training one or more large language models using the alignment training dataset.
24. The one or more non-transitory computer-readable media of any of clauses 21-23, wherein the steps further comprise encoding the plurality of alignment data elements using an encoder from a large language model to generating a plurality of encoded datapoints, and calculating the entropy of the dataset using probabilities of selecting each of the plurality of encoded datapoints.
25. The one or more non-transitory computer-readable media of any of clauses 21-24, wherein the steps further comprise modeling the plurality of encoded datapoints using a Gaussian mixture model.
26. The one or more non-transitory computer-readable media of any of clauses 21-25, wherein the subset of the plurality of alignment data elements includes alignment data elements having respective entropy change values that are larger than respective entropy change values of unselected ones of the plurality of alignment data elements.
27. The one or more non-transitory computer-readable media of any of clauses 21-26, wherein generating the alignment training dataset comprises selecting a predetermined number of alignment data elements corresponding to the plurality of alignment data elements having largest respective entropy change values.
28. The one or more non-transitory computer-readable media of any of clauses 21-27, wherein the predetermined number is ten percent of the alignment data elements in the dataset.
29. The one or more non-transitory computer-readable media of any of clauses 21-28, wherein the predetermined number is selected to control an amount of computing resources used when alignment training a large language model using the alignment training dataset.
30. The one or more non-transitory computer-readable media of any of clauses 21-29, wherein a respective alignment data element of the alignment data elements comprises at least one of input for a large language model, a response from the large language model, an input-response pair associated with the large language model, or a session comprising a plurality of input-response pairs associated with the large language model.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

1. One or more non-transitory computer-readable media storing instructions that, when executed by one or more processors, cause the one or more processors to perform steps of:
retrieving a dataset comprising a plurality of alignment data elements;
calculating an entropy for the dataset;
for each alignment data element, calculate a respective entropy change value based on a difference between the entropy of the dataset and an entropy specific to the alignment data element; and
generating an alignment training dataset comprising a subset of the plurality of alignment data elements that are identified based on the respective entropy change values.

2. The one or more non-transitory computer-readable media of claim 1, wherein the steps further comprise determining the entropy specific to a first alignment data element based on an entropy of the dataset with the first alignment data element removed.

3. The one or more non-transitory computer-readable media of claim 1, wherein the steps further comprise:
training one or more large language models using the alignment training dataset.

4. The one or more non-transitory computer-readable media of claim 1, wherein the steps further comprise:
encoding the plurality of alignment data elements using an encoder from a large language model to generating a plurality of encoded datapoints; and
calculating the entropy of the dataset using probabilities of selecting each of the plurality of encoded datapoints.

5. The one or more non-transitory computer-readable media of claim 4, wherein the steps further comprise modeling the plurality of encoded datapoints using a Gaussian mixture model.

6. The one or more non-transitory computer-readable media of claim 1, wherein the subset of the plurality of alignment data elements includes alignment data elements having respective entropy change values that are larger than respective entropy change values of unselected ones of the plurality of alignment data elements.

7. The one or more non-transitory computer-readable media of claim 1, wherein generating the alignment training dataset comprises:
selecting a predetermined number of alignment data elements corresponding to the plurality of alignment data elements having largest respective entropy change values.

8. The one or more non-transitory computer-readable media of claim 7, wherein the predetermined number is ten percent of the alignment data elements in the dataset.

9. The one or more non-transitory computer-readable media of claim 7, wherein the predetermined number is selected to control an amount of computing resources used when alignment training a large language model using the alignment training dataset.

10. The one or more non-transitory computer-readable media of claim 1, wherein a respective alignment data element of the alignment data elements comprises at least one of: input for a large language model, a response from the large language model, an input-response pair associated with the large language model, or a session comprising a plurality of input-response pairs associated with the large language model.

11. A computer-implemented method for generating alignment training data, the method comprising:
retrieving a dataset comprising a plurality of alignment data elements;
calculating an entropy for the dataset;
for each alignment data element, calculate a respective entropy change value based on a difference between the entropy of the dataset and an entropy specific to the alignment data element; and
generating an alignment training dataset comprising a subset of the plurality of alignment data elements that are identified based on the respective entropy change values.

12. The computer-implemented method of claim 11, wherein the steps further comprise determining the entropy specific to a first alignment data element based on an entropy of the dataset with the first alignment data element removed.

13. The computer-implemented method of claim 11, further comprising:
training one or more large language models using the alignment training dataset.

14. The computer-implemented method of claim 11, further comprising:
encoding the plurality of alignment data elements using an encoder from a large language model to generating a plurality of encoded datapoints; and
calculating the entropy of the dataset using probabilities of selecting each of the plurality of encoded datapoints.

15. The computer-implemented method of claim 14, further comprising modeling the plurality of encoded datapoints using a Gaussian mixture model.

16. The computer-implemented method of claim 11, wherein the subset of the plurality of alignment data elements includes alignment data elements having respective entropy change values that are larger than respective entropy change values of unselected ones of the plurality of alignment data elements.

17. The computer-implemented method of claim 11, wherein generating the alignment training dataset comprises:
selecting a predetermined number of alignment data elements corresponding to the plurality of alignment data elements having largest respective entropy change values.

18. The computer-implemented method of claim 17, wherein the predetermined number is ten percent of the alignment data elements in the dataset.

19. The computer-implemented method of claim 17, wherein the predetermined number is selected to control an amount of computing resources used when alignment training a large language model using the alignment training dataset.

20. The computer-implemented method of claim 11, wherein a respective alignment data element of the alignment data elements comprises at least one of: input for a large language model, a response from the large language model, an input-response pair associated with the large language model, or a session comprising a plurality of input-response pairs associated with the large language model.

21. A system comprising:
a memory storing instructions; and
one or more processors coupled to the memory and, when executing the instructions, are configured to perform steps comprising:
retrieving a dataset comprising a plurality of alignment data elements;
calculating an entropy for the dataset;
for each alignment data element, calculate a respective entropy change value based on a difference between the entropy of the dataset and an entropy specific to the alignment data element; and
generating an alignment training dataset comprising a subset of the plurality of alignment data elements that are identified based on the respective entropy change values.

22. The system of claim 21, wherein the steps further comprise determining the entropy specific to a first alignment data element based on an entropy of the dataset with the first alignment data element removed.

23. The system of claim 21, wherein the steps further comprise:
training one or more large language models using the alignment training dataset.

24. The system of claim 21, wherein the steps further comprise:
encoding the plurality of alignment data elements using an encoder from a large language model to generating a plurality of encoded datapoints; and
calculating the entropy of the dataset using probabilities of selecting each of the plurality of encoded datapoints.

25. The system of claim 24, wherein the steps further comprise modeling the plurality of encoded datapoints using a Gaussian mixture model.

26. The system of claim 21, wherein the subset of the plurality of alignment data elements includes alignment data elements having respective entropy change values that are larger than respective entropy change values of unselected ones of the plurality of alignment data elements.

27. The system of claim 21, wherein generating the alignment training dataset comprises:
selecting a predetermined number of alignment data elements corresponding to the plurality of alignment data elements having largest respective entropy change values.

28. The system of claim 27, wherein the predetermined number is ten percent of the alignment data elements in the dataset.

29. The system of claim 27, wherein the predetermined number is selected to control an amount of computing resources used when alignment training a large language model using the alignment training dataset.

30. The system of claim 21, wherein a respective alignment data element of the alignment data elements comprises at least one of: input for a large language model, a response from the large language model, an input-response pair associated with the large language model, or a session comprising a plurality of input-response pairs associated with the large language model.
